(19) United States
(12) Patent Application Publication
(10) Pub. No.: US 2005/0076018 A1
(43) Pub. Date: Apr. 7, 2005

(54) Sorting result buffer

(76) Inventor: Burkhard K. Neidecker-Lutz, Karlsruhe (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/679,498

(22) Filed: Oct. 7, 2003

(51) Int. Cl. G06F 7/00

(52) U.S. Cl. 707/3

(57) ABSTRACT

A data store query system includes a data store that stores a collection of data, a sorted result buffer, and a query interface operable to receive a limit and order query and to identify data in the data store that satisfies the limit and order query using the sorted result buffer. Additionally, a method for satisfying limit and order queries includes receiving a limit and order query that includes a limit criteria specifying a maximum number of records for a result set of records satisfying the limit and order query and an order criteria, filling a sorted result buffer with records from a data store, and iteratively reformulating the limit and order query and updating the sorted result buffer until the sorted result buffer contains the result set of records satisfying the limit and order query.

### TECHNICAL FIELD

This disclosure is directed to a computer system and techniques for responding to data queries.

### BACKGROUND

A data store is any collection of information or data in a computer system such that the data is accessible by one or more software applications. For example, a file system populated with various files is a data store. When a data store is organized to facilitate search and retrieval of information contained within the data store, the data store is a database. Data stores and databases may be used for a wide variety of applications that may need to perform tasks such as the following: (1) inserting data into the data store; (2) deleting data from the data store; (3) modifying data in the data store; (4) organizing data; (5) searching for data matching search criteria; or (6) retrieving data. Some data stores provide a query interface to provide a mechanism to facilitate some or all of these tasks. A query interface facilitating these tasks in a database system is referred to as a database management system (DBMS).

Many query interfaces are designed to receive and processor data store queries formulated using the Standard Query Language (SQL) which has been adopted as a standard by the American National Standards Institute (ANSI) and the International Standards Organization (ISO).

### SUMMARY

In one general aspect, a data store query system includes a data store that stores a collection of data, a sorted result buffer, and a query interface operable to receive a limit and order query and to identify data in the data store that satisfies the limit and order query using the sorted result buffer. The data store may be implemented using any data storage device, such as, for example, a database or a fast cache.

In some implementations, the collection of data includes a table having an attribute, and the query interface is operable to receive the limit and order query placing order constraints on the attribute. The query interface creates a revised sorted result buffer in response to a modification of the limit and order query, the modification being made during a pause in execution of the limit and order query. The sorted result buffer is stored in a data storage device, such as, for example, random access memory. The limit and order queries may be formulated using standard query language (SQL).

Implementations of the query interface may support limit and order queries specifying the first N records satisfying the query and/or the last N records satisfying the query. The query interface is operable to identify data in the data store that satisfies the limit and order query using the sorted result buffer by iteratively reformulating the limit and order query until the sorted result buffer contains data satisfying the limit and order query.

In another general aspect, a method for satisfying limit and order queries includes receiving a limit and order query that includes both of an order criteria and a limit criteria, the limit criteria specifying a maximum number of records for a result set of records satisfying the limit and order query, filling a sorted result buffer with records from a data store, and iteratively reformulating the limit and order query and updating the sorted result buffer until the sorted result buffer contains the result set of records satisfying the limit and order query. The limit and order query may be specified using standard query language (SQL).

In some implementations, filling a sorted result buffer with records from the data store includes scanning the data store without consideration of the order criteria to identify records otherwise satisfying the limit and order query, and placing identified records into the sorted result buffer until the sorted result buffer includes the maximum number of records specified by the limit criteria. This technique may be used to satisfy limit and order query requests for the first N records satisfying the query by iteratively reformulating the query by identifying a last record of the sorted result buffer and reformulating the limit and order query to include a search criteria requesting records occurring before the last record in the order specified by the order criteria. Similarly, the technique may be used to satisfy a limit and order query requesting the last N records by identifying a first record of the sorted result buffer, and reformulating the limit and order query to include a search criteria requesting records occurring after the first record in the order specified by the order criteria.

In another general aspect, an apparatus includes a storage medium having instructions stored thereon. The instructions include a first code segment for obtaining a desired data set from a data store by executing a query, the query designed to return a set of data records from the data store and including a limit condition and an order condition, a second code segment for filling a sorted result buffer with the set of data records, a third code segment for pausing execution of the query, and a fourth code segment for modifying a threshold condition of the query, based on a selected data record within the set of data records, whereupon the first code segment resumes execution of the query and the second code segment filters the set of data records within the sorted result buffer based on the threshold condition to obtain a filtered data set.

In some implementations, the threshold condition may be based on a selected data record within the set of data records. The threshold condition may be related to a sort order associated with the desired data set, such that the query returns data records having a pre-determined relationship to the selected data record with respect to the sort order.

The second code segment may fill the sorted result buffer by inserting a result of the query and deleting the selected data record from the sorted result buffer. In this case, a size of the sorted result buffer may remain constant and may be determined based on the limit condition.

The first code segment may execute the query be traversing rows of a data table, and the third code segment pauses execution of the query at a first row corresponding to the filling of the sorted result buffer. In this case, the first code segment may resume execution of the query, after modification thereof, at a second row consecutively following the first row.

The details of one or more implementations are set forth in the accompanying drawings and the description below. Other features and advantages will be apparent from the description and drawings, and from the claims.

### DESCRIPTION OF DRAWINGS

FIG. 1 is a block diagram of software applications interacting with various data stores through query interfaces.

FIG. 2 is a diagram of the execution of a query on a data store to retrieve the first specified number of records in an indicated order.

FIG. 3 is a diagram of the execution of a query using a sorted result buffer to satisfy limit and order queries.

FIG. 4 is a block diagram of a query interface using a sorted result buffer to satisfy certain queries.

FIG. 5 is a flow chart of a process for satisfying a query using a sorted result buffer for limit and order queries.

### DETAILED DESCRIPTION

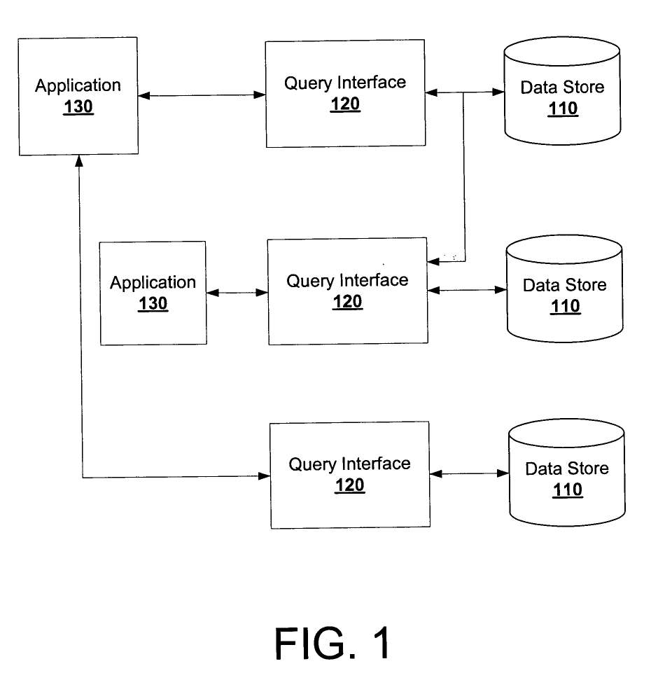

Referring to FIG. 1, a data store 110 provides a mechanism to maintain a collection of data or information that may be searched using a query interface 120, which allows an application 130 to submit queries to perform tasks such as data search and retrieval. A data store 110 may be implemented using any available data storage technology from a simple file system, to a complex transactional databases. FIG. 1 illustrates some example system architectures for various systems that could use the techniques described herein. The capabilities of the data store 110 may vary depending on the requirements of a particular application 130. For example, a computer file system may be viewed as a data store 110. A file system typically stores a variety of data identified, each identified by a name such that a user or application may retrieve the information when needed. To facilitate retrieval, file systems are often arranged in a hierarchical directory structure so that a user may identify the desired information by traversing the directories. A file system data store 110 does not usually facilitate complex search and retrieval functionality.

Some applications 130 require great flexibility and demand high performance in manipulating, querying, and retrieving data. For example, business applications (e.g., a customer relationship management (CRM) system, an enterprise resource planning (ERP) system, or a supply chain management (SCM) system) may require the processing and analysis of a great volume of transaction data. These application typically use a large database application as a data store 110, such as, for example, Oracle or Microsoft SQL Server. These databases usually provide an SQL-standard query interface 120 such that applications may formulate database queries.

The example system shown in FIG. 1 illustrates three data stores 110 coupled to three query interfaces 120 to support two applications 130. The first application 130 is coupled to two query interfaces 120, each providing access to a data store 110. This allows the application 130 to utilize data from both data stores 110, which could be used, for example, to search and retrieve information from the first data store 110 and to search and retrieve related information from the second data store 110. The second application 130 is coupled to a single query interface 120 that is in turn coupled to two data stores 110. This design could be useful to distribute data among the two data stores 110 or to otherwise access multiple data sources.

The data store 110 is typically implemented in software on one or more computer systems. The query interface 120 is an application that may run on the same computer system(s) as the data store 110 or may be run on a separate computer system, accessing the data store 110 through a network. In some implementations, the query interface 120 is integral to the data store 110, with the query interface 120 functionality built-in to the data store 110.

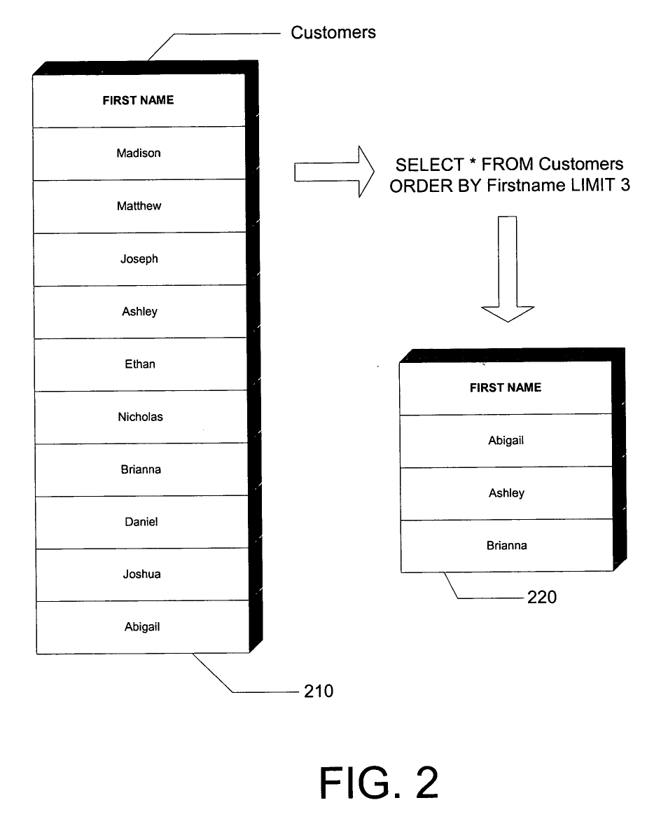

Referring to FIG. 2, consider a data store 110 with a table 210 entitled “Customers” that includes one or more attributes. In this example, only the “FirstName” attribute is shown. For each customer in the data store 110, a record is provided that lists the customer's first name. In practice, the Customers table 210 would include multiple attributes, such as, for example, the customer's last name, address, or phone numbers. A query interface 120 supporting SQL allows an application 130 to access the data store 110 to select records from the Customers table 210. For example, the following SQL statement would select all customers from the table 210 having the name “Joseph”:
SELECT * FROM Customers WHERE FirstName=“Joseph.”

The application 130 may include a graphical user interface (GUI) such that records retrieved from the data store 110 are displayed using the GUI. Only a limited number of records may be simultaneously displayed on a GUI screen, so it is useful to be able to specify a query statement that only returns a limited number of values in a result set. For example, the following SQL statement is operable to return the first three records from the Customers table 210:
SELECT * FROM Customers LIMIT 3.

Using table 210, this query would return the first three records (i.e., “Madison,” “Matthew,” and “Joseph”). In this manner, queries may be formulated to return only those records needed by an application 130 without unnecessarily requiring the creation of large result sets. For example, a query of a large customer database 110 for all records with a first name of “Joseph” may return many records. If an application 130 only needs the first 25 records, a LIMIT statement may be used to prevent the creation of a result set containing each “Joseph.”

In addition to supporting queries limiting the number of result records, a query interface 120 may allow a query to specify an order that result records are returned. For example, the following SQL statement requests Customer records listed in alphabetical order by each customer's first name:
SELECT * FROM Customer ORDER BY FirstName.

The limit and order features may be combined to allow a query interface 120 to support search and retrieval requests for a limited number of records with the records sorted in a particular order. FIG. 2 illustrates the result set for the following SQL statement:
SELECT * FROM Customer ORDER BY FirstName LIMIT 3.
In this example, the query interface 120 builds a result set containing the first three records when the Customers table 210 is placed in alphabetical order by each customer's first name. In this example, the result set includes the following: “Abigail,” “Ashley,” and “Brianna.”

A limit and order query is any query that places limits on the number of records returned as well as constraints on the order of data records in a result set if no limits on the number of records returned were imposed.

A query interface 120 may satisfy limit and order queries in several ways. First, the system can build a result set, sort the result set, and cut off all but the number of records selected. Using this technique, the query interface 120 would execute the statement
SELECT * FROM Customer
to return a list of customer records as follows: “Madison,” “Matthew,” “Joseph,” “Ashley,” “Ethan,” “Nicholas,” “Brianna,” “Daniel,” “Joshua,” and “Abigail.”

This result set is then sorted in the indicated order. In this case, the result set is sorted as follows: “Abigail,” “Ashley,” “Brianna,” “Daniel,” “Ethan,” “Joseph,” “Joshua,” “Madison,” “Matthew,” and “Nicholas.” Finally, the result set is cut off to return the specified number of records, resulting in the following: “Abigail,” “Ashley,” and “Brianna.”

Another technique that may be used to satisfy limit and order queries is to first sort the data based on the specified order criteria. Then, the indexed data may be traversed to select the specified number of records. In this example, the table 210 is indexed on the FirstName attribute. The index is then walked to retrieve the first three records: “Abigail,” “Ashley,” and “Brianna.” This technique only requires a result set capable of holding the number of requested records. Once the data has been appropriately indexed, this technique may be used to efficiently retrieve the requested records.

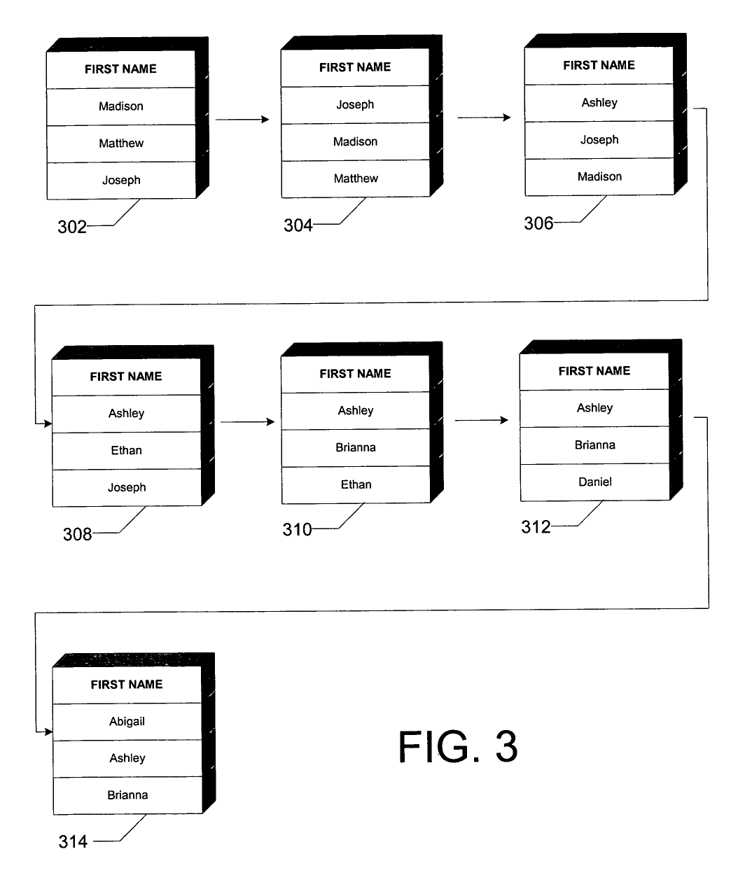

Referring to FIG. 3, another technique may be used to satisfy limit and order queries without building result sets larger than the number of results requested and without indexing the table 210. An iterative process may be used as illustrated to modify a query as it is running, such that records are placed and then re-placed, as needed, within a result set until the requested records are identified and ordered appropriately.

First, execution of an initial version of a query is enacted to obtain records which populate the result set. In this example, execution of the following SQL statement is begun:
SELECT * FROM Customers ORDER by FirstName LIMIT 3.
Initial execution of this statement satisfies the limit condition without regard for the order condition, returns the first three record from the Customers table 210, and places them in result set 302. In this example, result set 302 contains “Madison,” “Matthew,” and “Joseph.” The result set 302 is then ordered alphabetically to result in the result set 304, listing “Joseph,” “Madison,” and “Matthew.”

The query interface 120 then uses an iterative approach, in which execution of the query is paused, the query is modified, and execution is resumed at the current table location, so as to thereby improve the result set. To modify the query in this manner, the query interface 120 uses the assumption that if the current result set does not include the first three names in alphabetical order, then there must be at least one name before the last entry in the result set 302. In this case, the last entry in the result set 304 is “Matthew,” so the query is modified as follows:
SELECT * FROM Customers WHERE FirstName<‘Matthew’ ORDER by FirstName LIMIT 3.

The query proceeds in the table 210 at the location at which execution was previously paused, and determines that the next entry, “Ashley,” does, in fact, occur alphabetically before “Matthew.” Therefore, the record “Matthew” is removed, and a result set 306 is created, which includes the three records “Ashley,” “Joseph,” and “Madison.”

The iterative process continues as the query interface 120 modifies the query statement to have a new condition or requirement that the next-selected record, if any, include a first name before the current last name of “Madison.” Since the next record “Ethan” occurs before “Madison,” “Madison” is removed and “Ethan” is added, resulting in a sorted result set 308 that includes “Ashley,” “Ethan,” and “Joseph.”

The iterative process is repeated with the query interface 120 modifying the query statement to select those records with a first name before “Joseph.” At this point, the next record in the table 210 is the record “Nicholas,” which is not before “Joseph” and is therefore not included. Rather, the next record, “Brianna,” is selected, so that the query returns the result set 310 with Joseph excluded and including “Ashley,” “Brianna,” and “Ethan.” Similarly, the query is modified to obtain a result set 312 including the records “Ashley,” “Brianna,” and “Daniel,” and modified again to obtain a result set 314 of “Abigail,” “Ashley,” and “Brianna.” At this point, the query condition becomes FirstName<Brianna, a condition that no other name meets in table 210, particularly since an end of the table 210 has been reached at this point.

Using this technique, the query interface 120 is able to build a result set that satisfies a limit and order query that is no bigger than the requested number of records. This technique also may be performed without indexing the table 210. Moreover, since the process of adding records in the result set(s) merely requires replacing records having a higher sort order, the storage requirements of the process remain constant throughout. As the process progresses, the modified query includes a condition that is progressively strengthened (e.g., in the example discussed above, the threshold condition moves ever closer to the beginning of the alphabet). As a result, as the process progresses, fewer insert operations are needed (i.e., more records are skipped over), even for very large result sets.

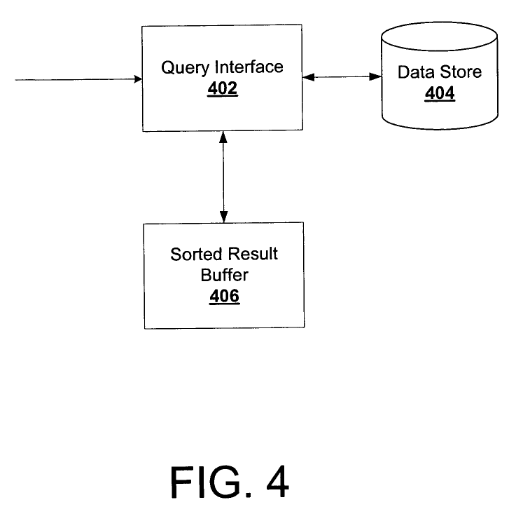

Referring to FIG. 4, a system includes a query interface 402 that receives requests for certain data or information in data store 404 and a sorted result buffer for satisfying limit and order queries without necessitating the indexing of data in the data store 404. A sorted result buffer 406 is a block of data storage used by the query interface 402 to respond to limit and order queries. Typically, the sorted result buffer 406 is stored in random access memory (RAM) or other working data storage. In some implementations, one or more sorted result buffers 406 are provided and used (or reused) as needed to satisfy limit and order queries. In other implementations, sorted result buffers 406 are allocated as needed by the query interface 402.

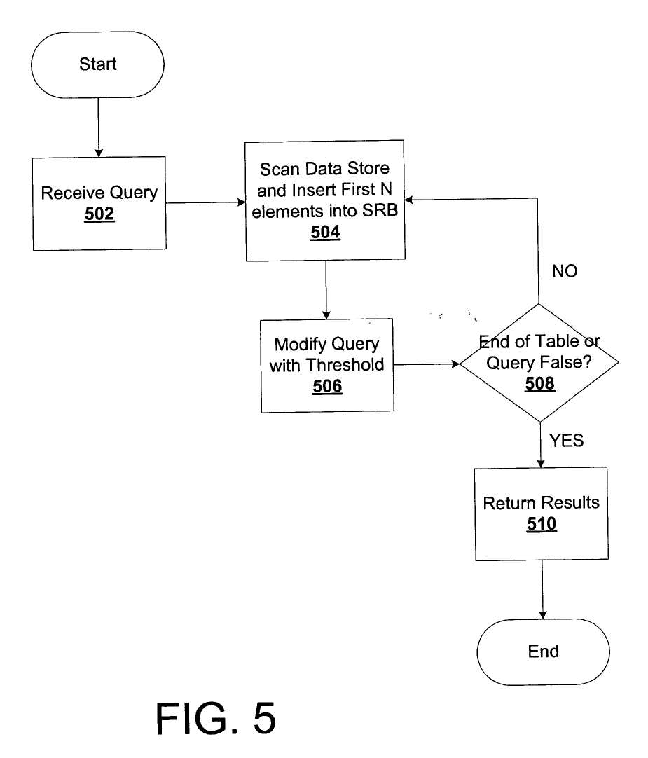

A sorted result buffer 406 may be used by any system that supports limit and order queries (i.e., queries that specify an order and maximum size for result sets). Each of the system components may be implemented on a single computer system, or the components may be distributed across multiple computer systems. Additionally, each of the components may be provided by a single software process or by multiple processes. Referring to FIG. 5, a method for satisfying limit and order queries includes receiving a query (step 502). In the examples provided herein, queries are specified using SQL; however, this technique may be used with any query language or query method supported by a query interface 402. In SQL, a query statement that includes a “LIMIT” phrase and a “ORDER BY” phrase is a limit and order query that may be satisfied using this technique.

To satisfy a limit and order query limiting the result set to N results, the system scans records in the data store 404 matching the query (less any order phrase) and inserts the first N records into a sorted result buffer 406 (step 504). For example, the following SQL statement would cause the system to scan the records in the Customer table 210, placing the first 5 records in the sorted result buffer 406: “SELECT * FROM Customer ORDER BY FirstName LIMIT 5.” The system uses the “ORDER BY FirstName” limitation to iteratively change queries until the requested records are identified; however, this order phrase is not directly used to retrieve records. In this example, the system would select the first 5 records matching “SELECT * FROM Customer.”

The selected records are sorted based on the “ORDER BY” criteria and inserted in the sorted result buffer 406. When records are inserted or deleted from the sorted result buffer 406, the contents of the buffer 406 are reordered, if necessary, such that the contents of the buffer 406 remain sorted.

If the data store 404 does not include more records than the number specified by a “LIMIT” criteria, then the contents of the sorted result buffer 406 satisfy the query and may be returned by the query interface 402.

At this point, the sorted result buffer 406 contains the number of records specified by the “LIMIT” criteria; however, the sorted result buffer 406 may include records other than the first N in sorted order. If the number of sorted records includes records other than those satisfying the query, then there must be at least one record in the data store 404 that is ordered before the last element in the sorted result buffer 406. To find such an element, the query may be reformulated to select only those records occurring before the last element of the sorted result buffer 406 (step 506). The example discussed with reference to FIG. 3 gives examples of query reformulation.

This iterative process continues until the last record of a reformulated query is used, or until the reformulated query returns zero matches (step 508). In some implementations, the query interface 402 may be able to determine whether or not a query will return any records without actually performing the query. If the query interface 402 (or data store 404) is able to determine that a query will not return any results, this information may be used to end the iterative process.

If the iterative process is complete, the system returns the results (step 510), otherwise, the system uses the reformulated query to iteratively scan the data store 404 and update the sorted result buffer 406 accordingly (step 504).

The techniques described above may be used to satisfy limit and order queries using minimal space to build a result set and without requiring indexing. This allows an application 130 to select the first N records matching a query. A similar technique may be used to satisfy queries requesting the last N records matching a query such as the following:
SELECT * FROM Customers ORDER BY FirstName LAST 3.

Using the example table 210 shown in FIG. 2, this query should return the following records: “Madison,” “Matthew,” and “Nicholas.” The method described with reference to FIG. 5 may be used by modifying how queries are reformulated.

First, the query interface 402 selects three records, sorts the records, and places them in a sorted result buffer 406. In this case, the sorted result buffer 406 contains the following: “Joseph,” “Madison,” and “Matthew.” If these three records are not the last three matching records in the data store 404, then at least one record must occur after the first record in the sorted result buffer 406 (i.e., “Joseph”). The search is reformulated as follows:
SELECT * FROM Customers WHERE FirstName>‘Joseph’.

The reformulated query is used to update the sorted result buffer to the following: “Madison,” “Matthew,” and “Nicholas” (i.e., skipping over “Ashley” and “Ethan” as non-matching records). The reformulated query would return “Joshua” as well as “Nicholas” so the query must again be reformulated as follows:
SELECT * FROM Customers WHERE FirstName>‘Madison’.
This query returns no additional records, so the sorted result buffer 406 satisfies the query and may be returned by the query interface 402.

The worst case performance occurs when matching data records are traversed in reverse sort order. To minimize the likelihood of this occurrence, matching data records may be traversed in random order.

The techniques described above may be used in any data store 110 including a database, a fast cache, or a main memory database. Though the examples described expressed limit and order queries using SQL syntax, the same techniques may be used to satisfy any limit and order queries, no matter how they are formulated.

A number of implementations have been described. Nevertheless, it will be understood that various modifications may be made. Accordingly, other implementations are within the scope of the following claims.

1. A data store query system comprising:
a data store that includes a collection of data;
a sorted result buffer; and
a query interface operable to receive a limit and order query and to identify data in the data store that satisfies the limit and order query using the sorted result buffer.

2. The data store query system of claim 1 wherein the data store is a database or a fast cache.

3. The data store query system of claim 1 wherein the collection of data includes a table having an attribute, and the query interface is operable to receive the limit and order query placing order constraints on the attribute.

4. The data store query system of claim 1 wherein the query interface creates a revised sorted result buffer in response to a modification of the limit and order query, the modification being made during a pause in execution of the limit and order query.

5. The data store query system of claim 1 wherein the sorted result buffer is stored in random access memory.

6. The data store query system of claim 1 wherein the query interface is operable to receive the limit and order query formulated using standard query language (SQL).

7. The data store query system of claim 1 wherein the query interface is operable to receive the limit and order query that requests the first or last N records satisfying the query.

8. The data store query system of claim 1 wherein the query interface is operable to identify data in the data store that satisfies the limit and order query using the sorted result buffer by iteratively reformulating the limit and order query until the sorted result buffer contains data satisfying the limit and order query.

9. A method for satisfying limit and order queries including:
receiving a limit and order query that includes both of an order criteria and a limit criteria, the limit criteria specifying a maximum number of records for a result set of records satisfying the limit and order query;
filling a sorted result buffer with records from a data store; and
iteratively reformulating the limit and order query and updating the sorted result buffer until the sorted result buffer contains the result set of records satisfying the limit and order query.

10. The method of claim 9 wherein the limit and order query is specified using standard query language (SQL).

11. The method of claim 9 wherein filling the sorted result buffer with records from the data store includes:
scanning the data store without consideration of the order criteria to identify records otherwise satisfying the limit and order query; and
placing identified records into the sorted result buffer until the sorted result buffer includes the maximum number of records specified by the limit criteria.

12. The method of claim 9 wherein the limit and order query requests the first N records satisfying the query, and further wherein reformulating the limit and order query includes:
identifying a last record of the sorted result buffer; and
reformulating the limit and order query to include a search criteria requesting records occurring before the last record in the order specified by the order criteria.

13. The method of claim 9 wherein the limit and order query requests the last N records satisfying the query, and further wherein reformulating the limit and order query includes:
identifying a first record of the sorted result buffer; and
reformulating the limit and order query to include a search criteria requesting records occurring after the first record in the order specified by the order criteria.

14. An apparatus comprising a storage medium having instructions stored thereon, the instructions including:
a first code segment for obtaining a desired data set from a data store by executing a query, the query designed to return a set of data records from the data store and including a limit condition and an order condition;
a second code segment for filling a sorted result buffer with the set of data records;
a third code segment for pausing execution of the query;
a fourth code segment for modifying a threshold condition of the query, whereupon the first code segment resumes execution of the query and the second code segment filters the set of data records within the sorted result buffer based on the threshold condition to obtain a filtered data set; and
a fifth code segment for determining that the filtered data set within the sorted result buffer matches the desired data set.

15. The apparatus of claim 14 wherein the threshold condition is based on a selected data record within the set of data records

16. The apparatus of claim 15 wherein the threshold condition is related to a sort order associated with the desired data set, such that the query returns data records having a pre-determined relationship to the selected data record with respect to the sort order.

17. The apparatus of claim 15 wherein the second code segment fills the sorted result buffer by inserting a result of the query and deleting the selected data record from the sorted result buffer.

18. The apparatus of claim 17 wherein a size of the sorted result buffer remains constant and is determined based on the limit condition.

19. The apparatus of claim 14 wherein the first code segment executes the query be traversing rows of a data table, and the third code segment pauses execution of the query at a first row corresponding to the filling of the sorted result buffer.

20. The apparatus of claim 19 wherein the first code segment resumes execution of the query, after modification thereof, at a second row consecutively following the first row.
